(19) United States
(12) Patent Application Publication
(10) Pub. No.: US 2007/0207912 A1
(43) Pub. Date: Sep. 6, 2007

(54) Method of making glass including use of boron oxide for reducing glass refining time

(75) Inventors: Richard Hulme, Rochester Hills, MI (US); Scott V. Thomsen, South Lyon, MI (US); Karl P. Platt, Corsicana, TX (US); Leonid M. Landa, Brownstown, MI (US); Ksenia A. Landa, Brownstown, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 11/365,808

(22) Filed: Mar. 2, 2006

(51) Int. Cl. C03C 3/089; C03B 5/16; C03C 3/091

(52) U.S. Cl. 501/65; 65/134.3; 501/66

(57) ABSTRACT

This invention relates to a method of making soda-lime-silica based glass. In certain example embodiments, boron oxide (e.g., B₂O₃) is used in the glass for reducing the refining time (or increasing the refining rate) thereof. The boron oxide may be introduced into the glass batch or melt in the form of boric acid, sodium tetraborate pentahydrate, sodium tetraborate decahydrate, sodium pentahydrate, or in any other suitable form. In certain example embodiments, the resulting soda-lime-silica based glass ends up including from about 0.1 to 3%, more preferably from about 0.1 to 2.5%, and most preferably from about 0.5 to 2.0% (e.g., about 1%), boron oxide. It has been found that the use of boron oxide, and/or the form in which the same is introduced into the glass, is advantageous in that it permits the refining time of the glass to be substantially reduced.

This invention relates to a method of making soda-lime-silica based glass. In certain example embodiments, boron oxide (e.g., such as boron trioxide) is used in the glass for reducing the refining time (or increasing the refining rate) thereof. The boron oxide may be introduced into the glass batch or melt in the form of one or more of boric acid, sodium tetraborate pentahydrate, sodium pentahydrate, or in any other suitable form. In certain example embodiments of this invention, the resulting soda-lime-silica based glass ends up including boron trioxide. It has surprisingly been found that the use of boron oxide, and/or the form in which the same is introduced into the glass melt or batch, is advantageous in that it permits the refining time of the glass to be substantially reduced (or the refining rate to be increased). Such glass compositions are useful, for example and without limitation, in architectural, vehicular and/or residential glass window applications.

### BACKGROUND OF THE INVENTION

This invention relates to glass compositions having improved refining and/or melting characteristics. In a conventional float line process, glass batch materials are heated in a furnace or melter to form a glass melt. The glass melt is poured onto a bath of molten tin (tin bath), where the glass melt is formed and continuously cooled to form a float glass ribbon. The float glass ribbon is cooled and cut to form solid glass articles, such as flat glass sheets. For float glass, the glass batch often includes soda, lime and silica to form soda-lime-silica based flat glass.

There is a tradeoff between glass production and the cost of manufacture. In particular, it is desirable to increase the rate of glass production but at the same time it is also desirable to reduce production costs. Certain glass manufacturers are operating their glass furnaces at higher and higher throughput and temperatures to meet the increased demand for glass. However, as more glass batch is processed, more fuel is required to melt the increased amounts of glass batch thereby increasing production costs and decreasing thermal efficiency.

Certain prior art has attempted to solve these problems. For example, U.S. Pat. No. 6,797,658 (the disclosure of which is hereby incorporated herein by reference) discloses decreasing the amount of MgO in the glass composition and increasing the amount of two or more of CaO, R₂O (Na₂O and K₂O), Al₂O₃, and SiO₂ by the same amount. The '658 Patent contends that the melting and/or forming temperature of the glass can be reduced in such a manner. See also U.S. Pat. No. 6,878,652 (decreasing MgO and increasing CaO by the same amount), and U.S. Pat. No. 5,071,796, the disclosures of which are hereby incorporated herein by reference. However, these compositions are problematic for numerous reasons and do not provide for the best results.

In view of the above, it will be apparent that there exists a need in the art for a method of making a soda-lime-silica based glass composition which may realize a reduced refining time and/or increased refining rate. In certain example instances it would be desirable to provide a glass composition that is able to realize a lower viscosity so that refining of the melt occurs faster in the float line manufacturing process, and/or a method of making such glass.

### SUMMARY OF EXAMPLE EMBODIMENTS OF THE INVENTION

This invention relates to a method of making soda-lime-silica based glass. In certain example embodiments, boron oxide (e.g., such as boron trioxide, B₂O₃) is used in the glass for reducing the refining time (or increasing the refining rate) thereof. The boron oxide may be introduced into the glass batch or melt in the form of one or more of boric acid (H₃BO₃), sodium tetraborate decahydrate (Na₂B₄O₇.10H₂O), sodium tetraborate pentahydrate, sodium pentahydrate (Na₂B₄O₇.5H₂O), or in any other suitable form. In certain example embodiments of this invention, the resulting soda-lime-silica based glass ends up including by weight percentage from about 0.1 to 3%, more preferably from about 0.1 to 2.5%, and most preferably from about 0.5 to 2.0% (e.g., about 1%), boron oxide (e.g., boron trioxide, B₂O₃). It has surprisingly been found that the use of boron oxide, and/or the form in which the same is introduced into the glass melt or batch, is advantageous in that it permits the refining time of the glass to be substantially reduced (or the refining rate to be increased). Such glass compositions are useful, for example and without limitation, in architectural, vehicular and/or residential glass window applications.

In certain example embodiments of this invention, there is provided a method of making soda-lime-silica based glass comprising a base glass portion that includes: SiO₂67-75%, Na₂O10-20%, CaO5-15%, Al₂O₃0-7%, K₂O 0-7%, the method comprising: providing boron oxide in a glass melt used in making the glass, the boron oxide acting to reduce refining time of the glass melt; and increasing a pull rate and/or reducing residence time of the glass melt in a refining zone of a glass manufacturing apparatus, compared to a situation where no boron oxide is present.

In other example embodiments of this invention, there is provided a method of making soda-lime-silica based glass, the method comprising: providing boron oxide in a glass melt used in making the soda-lime-silica based glass, in order to reduce refining time of the glass melt.

### BRIEF DESCRIPTION OF THE DRAWINGS

FIG. 1 is a graph/chart illustrating compositions and refining/optical characteristics associated with Examples 1-6.

### DETAILED DESCRIPTION OF CERTAIN EXAMPLE EMBODIMENTS OF THIS INVENTION

This invention relates to glass compositions having improved refining and/or melting characteristics. In a conventional float line process, glass batch materials are heated in a furnace or melter to form a glass melt. The glass melt is poured onto a bath of molten tin (tin bath), where the glass melt is formed and continuously cooled to form a float glass ribbon. The float glass ribbon is cooled and cut to form solid glass articles, such as flat glass sheets. For float glass, the glass batch often includes soda, lime and silica to form soda-lime-silica based flat glass.

The process by which bubbles are removed from glass melt when the vigorous reactions of melting are finished is called refining (or fining). The quality of refining has a significant effect on the quality of the final glass. The standards for number and size of seeds (bubbles) depend(s) on the eventual use of the glass. It is desirable to remove all seeds from the glass during the refining process; but from a practical point of view this is hardly possible and those skilled in the art strive to remove as many seeds as practically possible.

In making glass, after weighing and mixing the raw materials (e.g., sand, soda ash, dolomite, limestone, cullet, fluxes, refining and/or reducing agents), the batch is charged into the glass melt tank. The heating of the batch results in reactions between batch components, dissolution of solid grains and forming the glass melt that may still contain some un-melted batch particles. The melt is considered batch-free when all, or substantially all of, such particles are dissolved. After dissolution of most batch components, the glass melt contains dissolved gases and bubbles in sizes varying between about 20 micrometers to several millimeters. Some of these gases come from the breakdown of the raw materials, while some come from air that is entrapped between the grains of the batch. Examples gases in the bubbles include nitrogen, carbon dioxide, oxygen, sulfur dioxide, argon, and water vapor. Example mechanisms governing the refining of glass beyond batch-free time include (a) the rise of large seeds to the glass melt surface where they collapse, (b) coalescence of seeds to make bigger bubbles which rise faster when they collide, and (c) dissolution of small seeds.

The typical way of refining or fining is based on the addition of a certain amount of a compound or a combination of compounds, which start to decompose after exceeding a certain fining-onset temperature of the melt. In float glass production, sodium sulfate, or salt cake, is primarily used as a fining agent. These compounds release gas at elevated temperatures, thereby generating numerous large bubbles. As the bubbles quickly rise to the surface, they sweep the smaller bubbles in the melt along with them. For faster bubble removal, the temperature may be increased to decrease the melt viscosity to about 100 dPa·s. Fining also depends on the design and operating parameters of a furnace—the size of the refiner, the pull rate or residence time of the melt in the fining zone. Moreover, a temperature increase in general tends to accelerate refining.

In certain example embodiments of this invention, boron oxide is used as a refining or fining agent. The boron oxide is added to the batch in order to decrease seediness of the melt at the batch-free time and to reduce the time needed for complete refining. In other words, boron oxide (e.g., B₂O₃) is used in the glass for reducing the refining time (or increasing the refining rate) of the soda-lime-silica glass. The boron oxide may be introduced into the glass batch or melt in the form of one or more of boric acid (H₃BO₃), sodium tetraborate decahydrate (Na₂B₄O₇.10H₂O), sodium pentahydrate (Na₂B₄O₇.5H₂O), sodium tetraborate pentahydrate, or in any other suitable form. In certain example embodiments of this invention, the resulting soda-lime-silica based glass ends up including by weight percentage from about 0.1 to 3%, more preferably from about 0.1 to 2.5%, and most preferably from about 0.5 to 2.0% (e.g., about 1%), boron oxide (e.g., B₂O₃). In certain example embodiments, the glass-forming system remains basically that of basic soda-lime-silica matrix except that the introduction of boron oxide into the batch/melt suppresses other oxides such as silica, sodium oxide, which may be subject to adjustments of their amounts.

It has surprisingly been found that the use of boron oxide, and/or the form in which the same is introduced into the glass melt or batch, is advantageous in that it permits the refining time of the glass to be substantially reduced (or the refining rate to be increased). The introduction of the boron oxide improve glass refining, homogeneity and/or quality (e.g., lower seed count) through its flux action and improves glass optical parameters of green and clear glass for example through the change in refractive index and surface tension thereby decreasing reflection and/or light scattering. Boron oxide (e.g., B₂O₃) may cause a broader and weaker absorption band of a transition element(s) such as iron which may additionally improve the transmittance of low iron clear glass in certain example embodiments of this invention.

In certain example embodiments, the batch formulation may also rely on sulfate refining where, in the case of low or no dolomite introduction for example, part of all of magnesia can be introduced into the batch as Epsom salt, magnesium sulfate heptahydrate, MgSO₄.7H₂O.

An example soda-lime-silica base glass according to certain embodiments of this invention, on a weight percentage basis, includes the following basic ingredients:

TABLE 1
Example Base Glass

| Ingredient | Wt. % |
|---|---|
| SiO₂ | 67-75% |
| Na₂O | 10-20% |
| CaO | 5-15% |
| MgO | 0-7% |
| Al₂O₃ | 0-7% |
| K₂O | 0-7% |

Other minor ingredients, including various refining aids, such as salt cake, crystalline water and/or the like may also be included in the base glass. In certain embodiments, for example, glass herein may be made from batch raw materials silica sand, soda ash, dolomite, limestone, with the use of salt cake (SO₃) as a refining agent (or of course boron oxide as discussed above). Reducing and oxidizing agent(s) may also be used in certain instances. In certain instances, soda-lime-silica base glasses herein include by weight from about 10-15% Na₂O and from about 6-12% CaO.

In addition to the base glass materials discussed above, the glass batch and/or final glass may include a colorant portion including material(s) such as iron, erbium, cobalt, selenium and/or the like. In certain example embodiments of this invention, the amount of total iron in the glass may be from about 0.05 to 1.2%, more preferably from about 0.3 to 0.8%. In the case of certain clear high transmission glasses, the total iron may be from about 0.005 to 0.025%. The total amount of iron present in the glass, and thus in the colorant portion thereof, is expressed herein in terms of Fe₂O₃ in accordance with standard practice. This, however, does not imply that all iron is actually in the form of Fe₂O₃. Likewise, the amount of iron in the ferrous state is reported herein as FeO, even though all ferrous state iron in the glass may not be in the form of FeO. The proportion of the total iron in the ferrous state (i.e., FeO) is used to determine the redox state of the glass (i.e., glass redox), which is expressed as the ratio FeO/Fe₂O₃, which is the weight percentage (%) of iron in the ferrous state (expressed as FeO) divided by the weight percentage (%) of total iron (expressed as Fe₂O₃). Thus, Fe₂O₃ herein means total iron and FeO means iron in the ferrous state. Iron in the ferrous state (Fe²⁺; FeO) is a blue-green colorant, while iron in the ferric state (Fe³⁺) is a yellow-green colorant. According to certain embodiments of this invention, the colorant portion of the glass composition herein may include % FeO of from about 0.00015 to 0.2. In certain clear high transmission glass embodiments, the colorant portion may include % FeO of from about 0.00015 to 0.003, and a visible transmission and/or solar energy transmission of at least about 80%, more preferably at least about 85%, and most preferably at least about 90% or 91%.

In certain example embodiments herein, glasses may be characterized by one or more of the optical characteristics set forth below when measured at a nominal thickness of from about 1-6 mm. The a*, b*, L* color values used herein are transmissive, in accordance with the known x/y CIE color diagram.

### EXAMPLES 1-6

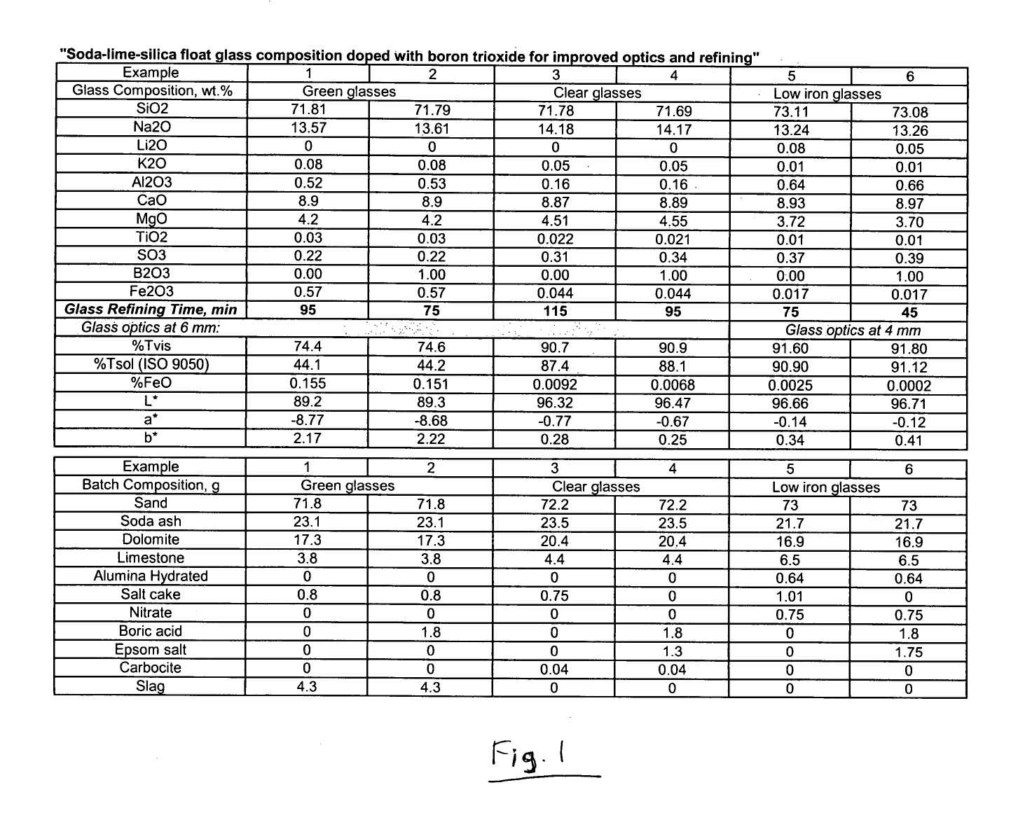

FIG. 1 illustrates the batch components, final glass compositions, and optics associated with Examples 1-6 of the instant invention. In FIG. 1, the batch components (e.g., sand, soda ash, boric acid, etc.) are at the bottom one third of the figure, the final glass composition components (e.g., SiO₂, Na₂O, B₂O₃, etc.) are at the top one third of the figure, and the optics (e.g., visible transmission, % Tvis, L*, a*, b*, etc.) associated with the final glasses are set forth at the middle portion of the figure. It will be appreciated from FIG. 1 that the glasses of Examples 1-2 were green glasses (note the rather high iron content of these glasses compared to the others), the glasses of Examples 3-4 were clear glasses with fairly neutral color, whereas the glasses of Examples 5-6 were low iron highly transmissive glasses (note the very low iron content and very high visible transmission characteristics).

Examples 1-6 illustrate that the use of boric oxide in the batch and the final glass unexpectedly improved refining characteristics. In particular, the use of the boron oxide significantly and unexpectedly reduced the refining times of the glasses. Examples 1, 3 and 5 used no boron oxide in the batch or final glass, and thus may be considered Comparative Examples (CEs). Examples 2, 4 and 6 were mainly the same as Examples 1, 3 and 5, respectively, except that Examples 2, 4 and 6 used about 1.8 grams of boric acid in the batch and the resulting glasses of Examples 2, 4 and 6 included about 1% by weight B₂O₃ (there were also some differences with respect to salt cake and/or Epsom).

It can be seen in FIG. 1 that the use of the boron oxide significantly improved the refining times of the glasses. In particular, the refining time of Example 2 (with boron oxide) was much better (less) than that of corresponding Example 1 (no boron oxide); the refining time of Example 4 (with boron oxide) was much better (less) than that of corresponding Example 3 (no boron oxide); and the refining time of Example 6 (with boron oxide) was much better (less) than that of corresponding Example 5 (no boron oxide).

Note that the term “refining time” as used herein is the time in minutes which it takes to free or substantially free the glass melt of seeds that contain gas at a temperature of from about 1425-1475 degrees C., more preferably about 1450 degrees C., such that the melt contains no more than about 7 seeds per square meter, more preferably no more than about 5 seeds per square meter.

As explained above, in certain example embodiments of this invention the resulting soda-lime-silica based glass ends up including by weight percentage from about 0.1 to 3%, more preferably from about 0.1 to 2.5%, and most preferably from about 0.5 to 2.0% (e.g., about 0.75-1.25%), of boron oxide (e.g., B₂O₃). Moreover, in certain example embodiments of this invention when boric acid is used to introduce the boron oxide into the batch, from about 1-6%, more preferably from about 1-3% of the batch is made up of boric acid. Additionally, in certain example embodiments of this invention, from about 0.2 to 5%, more preferably from about 0.25% to 3%, of the batch is made up of boron oxide.

Additionally, the use of Epsom salt, e.g., magnesium sulfate heptahydrate, MgSO₄.7H₂O, in the batch is also advantageous with respect to refining (e.g., see Examples 4 and 6). In certain example embodiments of this invention, from about 0.5 to 2.5%, more preferably from about 0.75 to 2%, of the batch is made up of Epsom salt. The Epsom salt includes crystalline water. The final glass may include from about 0.04 to 1%, more preferably from about 0.04 to 0.3% OH group(s), due to the crystalline water in the Epsom salt. The OH groups in the final glass indicate that oxygen that was brought into the batch by the crystalline water of the Epsom salt oxidized iron oxide for example, thereby improving refining in certain example instances. The crystalline water of the Epsom is good for refining in that it brings in more gas to the batch and causes larger bubbles to form thereby improving refining characteristics. By creating larger bubbles, the bubbles rise faster and take smaller bubbles with them, thereby reducing refining time for a given temperature.

It will be appreciated that by reducing refining times herein, it is possible to increase the pull rate (or reduce the residence time) of the melt in the fining/refining zone. In other words, the maker of the glass one it has been recognized that the boron oxide reduces the refining time, can also increase the pull rate (and/or reduce the residence time) of the melt in the fining zone. In certain example embodiments of this invention, the pull rate may be increased by from about 5 to 50%, more preferably from about 10 to 35%, compared to a situation where no boron oxide is used. In certain example embodiments, the residence time of the melt in the fining zone may be reduced by from about 5 to 50%, more preferably from about 10 to 35%, compared to a situation where no boron oxide is used. This speeds up the process of glass manufacture and can thus save significant costs and/or time.

Once given the above disclosure many other features, modifications and improvements will become apparent to the skilled artisan. Such features, modifications and improvements are therefore considered to be a part of this invention, the scope of which is to be determined by the following claims:

What is claimed is:

1. A method of making soda-lime-silica based glass comprising a base glass portion that includes:

| Ingredient | wt. % |
|---|---|
| SiO₂ | 67-75% |
| Na₂O | 10-20% |
| CaO | 5-15% |
| Al₂O₃ | 0-7% |
| K₂O | 0-7% |

the method comprising:
providing boron oxide in a glass melt used in making the glass, the boron oxide acting to reduce refining time of the glass melt; and
increasing a pull rate and/or reducing residence time of the glass melt in a refining zone of a glass manufacturing apparatus, compared to a situation where no boron oxide is present.

2. The method of claim 1, wherein the boron oxide is provided in the glass melt in an amount sufficient so that the final glass made using the melt includes from about 0.1 to 3% boron oxide.

3. The method of claim 1, wherein the boron oxide is provided in the glass melt in an amount sufficient so that the final glass made using the melt includes from about 0.5 to 2.0% B₂O₃.

4. The method of claim 1, wherein the boron oxide is provided in the glass melt in an amount sufficient so that the final glass made using the melt includes from about 0.75 to 1.25% B₂O₃.

5. The method of claim 1, wherein the boron oxide is introduced into the glass melt and/or a glass batch for the melt in a form of boric acid.

6. The method of claim 1, wherein the boron oxide is introduced into the glass melt and/or a glass batch for the melt in a form of sodium tetraborate pentahydrate or sodium tetraborate decahydrate.

7. The method of claim 1, wherein the boron oxide is introduced into the glass melt and/or a glass batch for the melt in a form of sodium pentahydrate.

8. The method of claim 1, further comprising providing Epsom salt in the glass melt and/or a batch for the melt so as to reduce the refining time.

9. A method of making soda-lime-silica based glass, the method comprising:
providing boron oxide in a glass melt used in making the soda-lime-silica based glass, in order to reduce refining time of the glass melt.

10. The method of claim 9, wherein the boron oxide is provided in the glass melt in an amount sufficient so that the final glass made using the melt includes from about 0.1 to 3% boron oxide.

11. The method of claim 9, wherein the boron oxide is provided in the glass melt in an amount sufficient so that the final glass made using the melt includes from about 0.5 to 2.0% B₂O₃.

12. The method of claim 9, wherein the boron oxide is provided in the glass melt in an amount sufficient so that the final glass made using the melt includes from about 0.75 to 1.25% B₂O₃.

13. The method of claim 9, wherein the boron oxide is introduced into the glass melt and/or a glass batch for the melt in a form of boric acid.

14. The method of claim 9, wherein the boron oxide is introduced into the glass melt and/or a glass batch for the melt in a form of sodium tetraborate pentahydrate or sodium tetraborate decahydrate.

15. The method of claim 9, wherein the boron oxide is introduced into the glass melt and/or a glass batch for the melt in a form of sodium pentahydrate.

16. The method of claim 9, further comprising providing Epsom salt in the glass melt and/or a batch for the melt so as to reduce the refining time.
